(19) United States
(12) Patent Application Publication
(10) Pub. No.: US 2009/0038230 A1
(43) Pub. Date: Feb. 12, 2009

(54) Device and method for weatherproofing an entryway

(76) Inventor: James R. Sargent, Rochester, NH (US)

Correspondence Address: Kevin M. Farrell;Pierce Atwood, Suite 350, One New Hampshire Avenue, Portsmouth, NH, 03801, US

(21) Appl. No.: 11/891,252

(22) Filed: Aug. 9, 2007

(51) Int. Cl. E06B 1/70

(52) U.S. Cl. 49/471

(57) ABSTRACT

The present invention is directed to a formed construction element for providing drainage from beneath an entry door threshold. The formed construction element comprises a rectangular base having left and right sidewalls, a back wall and a front edge to which a front flange attaches. The rectangular base is adapted for attachment to a subfloor and for receiving a threshold. Further, the rectangular base has an upper planar surface comprising a plurality of channels extending from the back wall to the front edge, and the channels are pitched to carry fluid by gravity flow from the back wall front edge of the rectangular base. The front flange comprises a plurality of vertically oriented ribs for creating a drainage volume between the front flange and an attached kickboard.

### BACKGROUND

1. Field of the Invention

The present invention relates generally to construction materials and more specifically to a construction device for weatherproofing an entry doorway.

2. Discussion of Background Information

Weatherproofing doorways that lead into an interior space from an exterior space always has existed as a challenge for builders, especially those in climates that experience a variety of inclement weather conditions. Rain, sleet, snow and any moisture in general may seep into and deteriorate an underlying structure. Creating a protective barrier at this most common point of water entry, therefore, is a necessity.

Current practices include providing a water barrier material and a watertight sealant under doorway frames and entryway thresholds. These materials, however, tend to trap moisture between the doorway threshold and the structure upon which that doorway rests. Trapping moisture in this area leads to mold and mildew growth and eventually to full deterioration of the underlying structure itself.

Some builders incorporate metal pan-like devices beneath doorway thresholds in an attempt to prevent fluid from seeping through to the underlying structure. These devices, however, fail to divert fluid away from the interior space and then away from the structure's exterior facade. Additionally, most of these devices require installation of a sealant between the threshold and the device, thereby creating a pocket for fluid retention. Additionally, pan-like devices that require no sealant improperly drain fluid away from the structure and instead allow the fluid to run down an exterior vertical wall causing damage to that area.

A need exists for an improved device for protecting a doorway entry from weather-related damage and for directing fluid and moisture away from an underlying structure so as to prevent any moisture-related damage.

### SUMMARY OF THE INVENTION

The present invention solves the problems associated with existing entryway weatherproofing devices and provides a reliable device and method for protecting an underlying structure from damage caused by inclement weather.

The present invention is directed to a formed construction element that provides drainage from beneath an entry door threshold. The formed construction element comprises a rectangular base and a front flange. The rectangular base has left and right sidewalls and a back wall that are interconnected and that project vertically upward from an upper planar surface, and the upper planar surface has a front edge. The rectangular base is adapted for attachment to a subfloor and for receiving a threshold. The upper planar surface further comprises a plurality of channels extending from the back wall to the front edge of the upper planar surface, and the channels are pitched to carry fluid by gravity flow from the back wall to the front edge of the rectangular base. The front flange attaches to the front edge of the bottom planar surface of the rectangular base and to the left and right sidewalls of the rectangular base. The front flange further comprises a plurality of vertically oriented ribs which provide an attachment surface for an entry kickboard which creates drainage volume between the front flange and the entry kickboard.

The present invention is also directed to a method of providing a construction device for providing drainage from beneath an entry door threshold. The method comprises providing a construction device comprising a rectangular base having left and right sidewalls and a back wall that are interconnected projecting vertically upward from an upper planar surface, the upper planar surface having a front edge. The rectangular base is adaptable for engaging with a subfloor and for receiving a threshold. The upper planar surface further comprises a plurality of channels extending from the back wall to the front edge of the upper planar surface, the channels being pitched to carry fluid by gravity flow from the back wall to the front edge of the rectangular base. The construction device also comprises a front flange attached to the front edge of a bottom planar surface of the rectangular base and to the left and right sidewalls of the rectangular base. The front flange further comprises a plurality of vertically oriented ribs which provide an attachment surface for an entry kickboard. The method further comprises positioning the construction device on the subfloor beneath an entry door and then positioning a threshold on the device.

### BRIEF DESCRIPTION OF THE DRAWINGS

These and other features, aspects, and advantages of the present invention will become better understood with reference to the following description, appended claims, and accompanying drawings where:

FIG. 1 shows a perspective view of one embodiment of the device of the present invention.

FIG. 2 shows another perspective view of one embodiment of the device of the present invention.

FIG. 3 shows a side cut away view of one embodiment of the device of the present invention in relation to other construction materials incorporated at a structure entryway.

FIG. 4 shows a front view of one embodiment of the device of the present invention in relation to other construction materials incorporated at a structure entryway.

FIG. 5 shows an enlarged cut away perspective view of one embodiment of the device of the present invention.

FIG. 6 shows a top view of one embodiment of the device of the present invention.

FIG. 7 shows a front view of one embodiment of the device of the present invention.

### DETAILED DESCRIPTION

The present device and method protect the framework of a structure from damage caused by environmental moisture seeping into the structure at a doorway leading between interior and exterior spaces. Specifically, the present invention diverts any fluid leakage from entering a house and rotting the floor and subfloor, and the present invention also prevents mold and mildew growth by redirecting fluid back outside and away from the house.

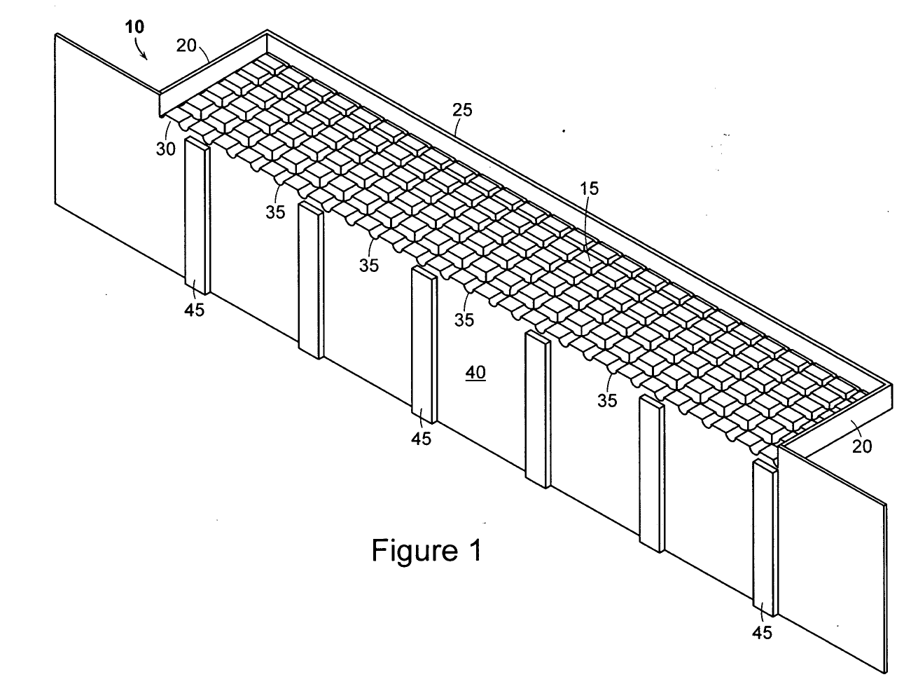

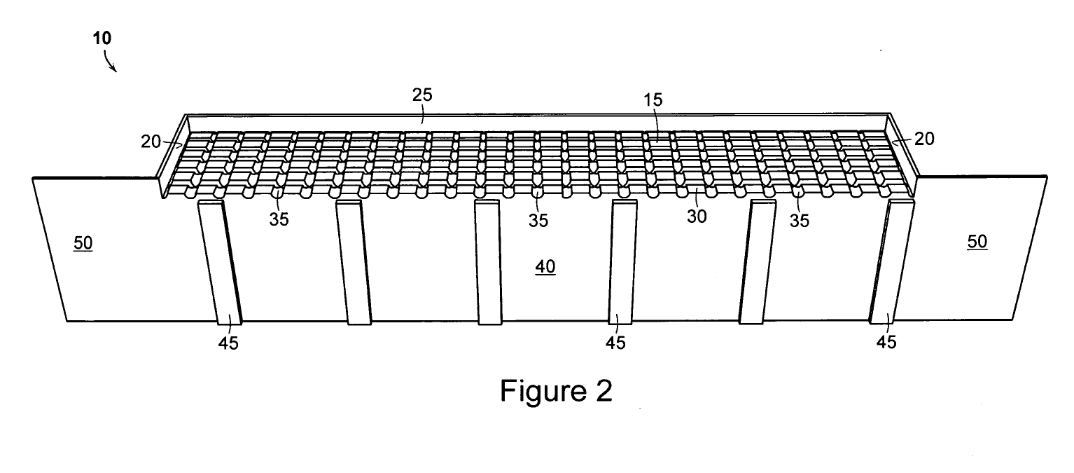

FIGS. 1 and 2 show one embodiment of a formed construction element 10 that provides drainage from beneath an entry door threshold. The construction element 10 comprises a rectangular base 15 having left and right sidewalls 20 and a back wall 25 that are interconnected and that project vertically upward from an upper planar surface of the rectangular base 15. The upper planar surface of the rectangular base has a front edge 30 and further comprises a plurality of channels 35 extending from the back wall 25 to the front edge of the upper planar surface 30. The channels 35 pitch downward to carry fluid by gravity flow from the back wall 25 to the front edge 30 of the rectangular base 15. The embodiment of the construction element 10 of FIGS. 1 and 2 demonstrates the plurality of channels 35 running the entire length of the construction element 10. The construction element 10 may provide greater or fewer channels 35 depending on a particular design need. Preferably, a sufficient quantity of channels 35 exist for fully redirecting moisture to the outdoors and away from an underlying structure.

A front flange 40 extends downwardly from the front edge 30 of a bottom planar surface of the rectangular base 15 and from the left and right sidewalls 20 of the rectangular base 15. The front flange 40 further comprises a plurality of vertically oriented ribs 45 which provide an attachment surface for an entry kickboard (not shown). This creates drainage volume through a plurality of vertically oriented channels formed between the front flange 40 and the entry kickboard and bounded by the vertically oriented ribs 45. The front flange 40 may further comprise side flanges 50 extending beyond the length of the rectangular base 15 for accommodating doorway openings of varying widths having trim of varying widths.

The embodiment of the construction element 10 depicted in FIGS. 1 and 2 demonstrate the plurality of vertically oriented ribs 45 being spaced apart over the length of the construction element 10. The construction element 10 may provide greater or fewer vertically oriented ribs 45 depending on a particular design need. For example, a larger entryway or a frequently-used entryway may require a greater number or denser pattern of vertically oriented ribs 45 for redirecting an increased volume of moisture in a highly controlled manner. Preferably, a sufficient quantity of ribs 45 exist for fully redirecting moisture to an exterior space and away from an underlying structure. FIGS. 1 and 2 depict one embodiment of the present invention having a vertically oriented rib 45 existing at about every fourth channel 35. This ratio of vertically oriented ribs 45 to channels 35 is variable as is the width of each vertically oriented rib 45.

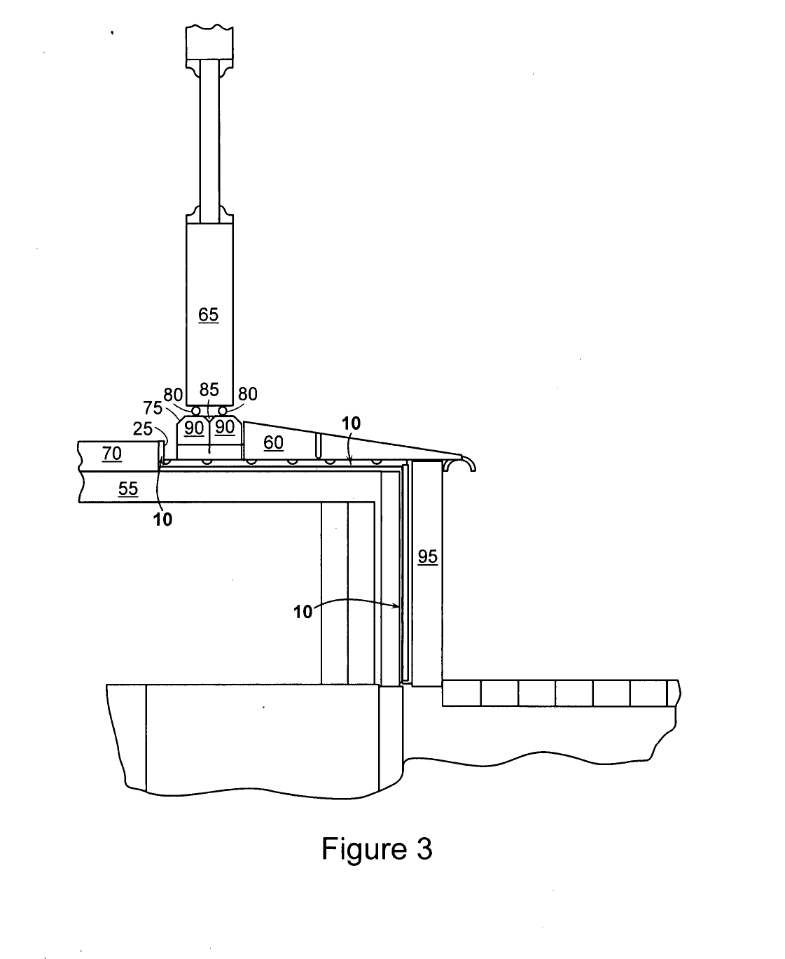

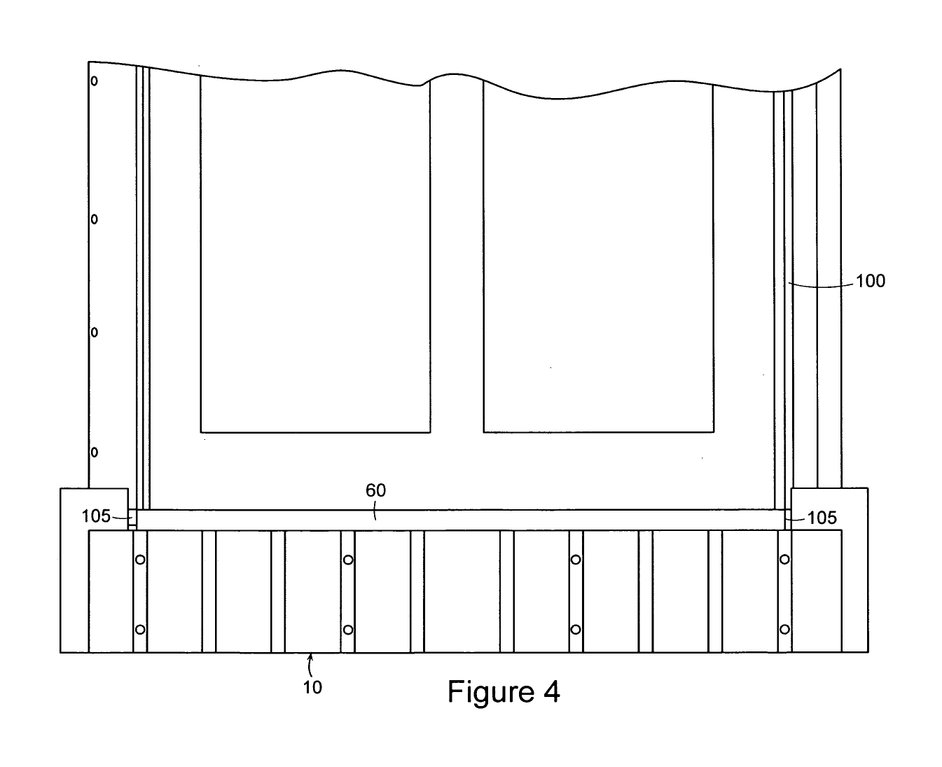

Turning now to FIG. 3 and FIG. 4, showing a cut away side view and a cut away front view respectively of the construction element 10 as installed upon a structure, the rectangular base 15 engages with a subfloor 55 and then receives thereon a threshold 60. The construction element 10 thus fits into a structure's frame, resting on the subfloor 55. The weight of a doorway threshold 60 and the door 65 thereabove render the construction element 10 immobile. As FIG. 3 depicts, the back wall 25 of the construction element 10 is unseen. Typically, exposed flooring 70 installed inside a structure, such a as a house, is ¾″ thick. The height of the back wall 25 maybe equal to or lesser than adjacent flooring 70 so that no physical obstruction and/or aesthetic detraction exist.

Additionally, no fasteners or adhesives are required to maintain placement of the construction element 10 on a subfloor 55. Application of an adhesive between the construction element 10 and the subfloor 55 is optional and will detracting nothing from proper functioning of the construction element 10. Puncturing the construction element 10 in any way, however, would defeat the intended purpose of protecting an underlying structure from moisture damage. Punctures would prevent absolute fluid removal because some seepage would occur necessarily at a puncture site.

Similarly, no fasteners or adhesives are required between the threshold 60 and the construction element 10, which is a major improvement over existing construction techniques. Most existing thresholds 60 are adjustable in that an adjustable portion 75 of the threshold 60 is adapted for lowering or lifting so as to contact door sweep seals 80. The adjustable portion 75 is thus provided in an attempt to create a watertight seal between the door sweep seals 80 and the threshold 60. By design though, the adjustable portion 75 incorporates adjusting screws 85 that also require sealing in an attempt to create a water tight seal. Typically though, these screw seals 90 fail after extended use or they fail because of improper installation. In either case, that failure allows moisture and fluid to bypass the screw seals 90 and reach an underlying structure.

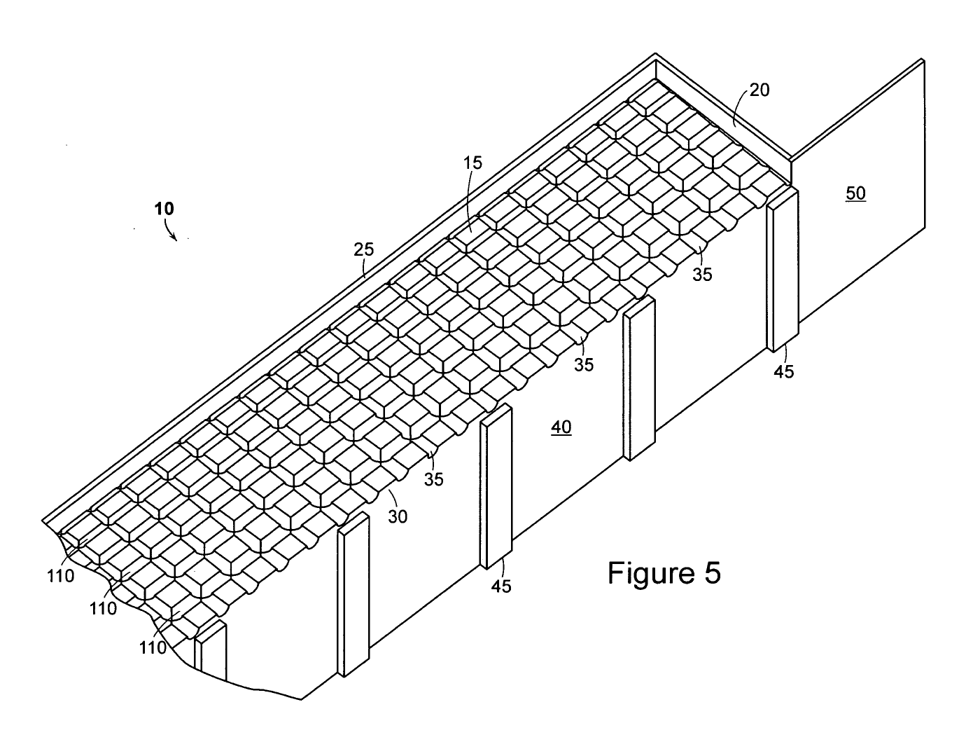

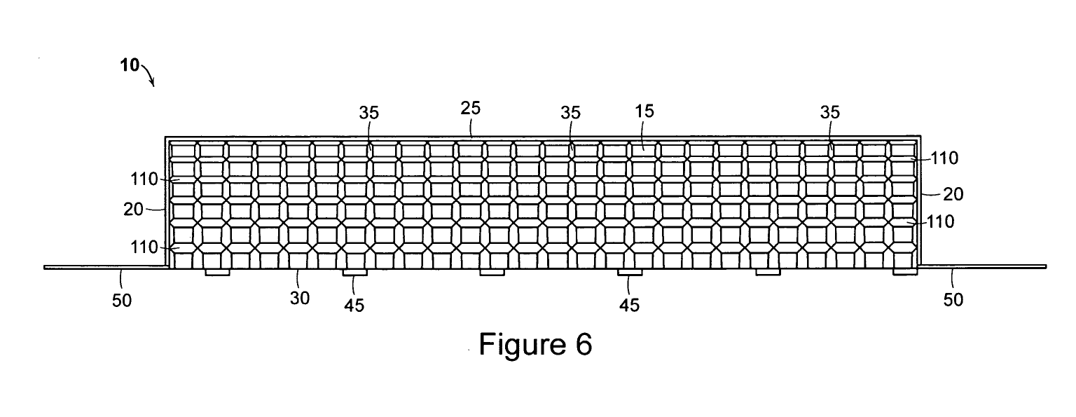

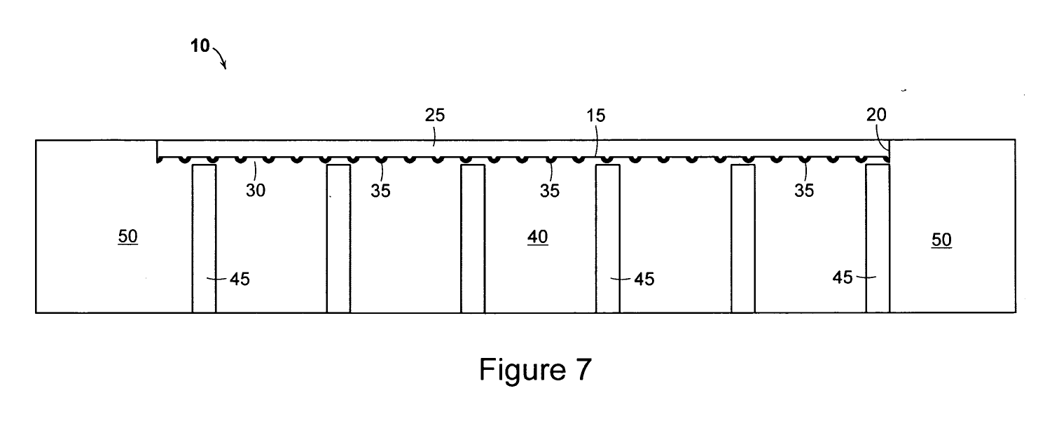

Because of this commonly occurring moisture leakage at the adjusting screws 85, typical installation of a door 65 requires application of a water barrier material and/or sealant under the threshold 60 and forward of water leaks occurring at the adjusting screws 85 and behind a kickboard 95 attached to the front flange 40. This technique effectively traps fluid and moisture inside the structure, inherently causing damage. By comparison, the construction element 10, as shown in FIG. 3, requires no sealant between the threshold 60 and the rectangular base 15. Instead of trapping moisture, the construction element 10 captures and redirects moisture descending from the threshold 60 back out to an exterior space and away from the structure. (The mechanism by which the construction element 10 redirects fluid is discussed in detail below with regard to FIGS. 5 through 7.)

As FIG. 3 further depicts, one embodiment of the construction element 10 accommodates framing materials, interior and exterior sheathing, and ice and/or water barrier materials, such as house wrap and Bituthene®. These materials are all typically incorporated into a structure during construction. The depth dimension of the rectangular base 15 as measured from the front edge 30 to the back wall 25 is great enough to accommodate these standard construction materials. In this regard, the construction element 10 requires no particular considerations or alterations of standard construction procedures, and, in fact, the present invention simplifies standard procedures by requiring no special installation of sealants in a number of locations during installation of the door 65.

For example, as FIG. 4 highlights, doors are generally 1 to 2.5″ smaller than door framing, leaving an adjustment gap 100 to allow for adjustment. The construction element 10 protects the structure beneath these areas by catching and redirecting moisture seepage from gap areas 105 formed beneath the adjustment gap 100 and beyond the threshold 60. Typically this gap area 105 provides a point of moisture leakage and structural deterioration, and builders attempt to fill this area with sealant, caulking, and/or water barrier material to try and prevent water entry. These methods are insufficient and generally fail to prevent water damage. By extending beneath the gap areas 105, the construction element 10 eliminates the need for incorporating these standard, insufficient water stoppage procedures and instead provides a foolproof solution.

In addition to providing a foolproof solution to water leakage problems created by adjustment gaps 100, the construction element 10 provides structural protection from moisture damage commonly associated with doors having windows therein, doors having metal exteriors and hollow cores, and doors having side light panels containing windows. Door windows and side light widows require installation of a sealant, such as caulking, around the perimeter of each pane. This sealant typically deteriorates and allows for fluid to run inside the hollow door or side light panel and directly onto a leaking adjustable threshold 60. Typically, sidelights attach to a door casing, and the sidelights and door receive a single mullion strip so as to present unified facade. This hidden point of attachment of the side light panel to the door casing, therefore, presents another potential area for fluid seepage. The construction element 10 extends beneath all of these areas for potential water leakage, capturing and redirecting any fluid back outdoors and away from the structure.

As referenced above in relation to FIGS. 1 through 3, the construction element 10 comprises design features that facilitate this fluid removal from beneath an entry door 60. FIGS. 5 through 7 clearly show these novel design elements. The upper planar surface of the rectangular base 15 comprises a plurality of channels 35 extending from the back wall to the front edge 30 of the upper planar surface. (For clarity, only a representative few of the channels 35 depicted are demarcated in FIGS. 1 and 2 and FIGS. 5 through 7.) The channels 35 are pitched downward from the back wall 25 to the front edge 30 so as to carry fluid back outdoors by gravity flow. To achieve this downward pitch, the plurality of channels 35 have a width and/or depth that progressively increases from the back wall 25 to the front edge of the upper planar surface of the rectangular base 15.

The upper planar surface of the rectangular base 15 further comprises a plurality of cross channels 110 that extend from the left side wall to the right sidewall. (For clarity, only a representative few of the cross channels 100 depicted are demarcated in FIGS. 5 through 7.) This plurality of cross channels 110 intersect the plurality of channels 35 extending from the back wall 25 to the front edge 30 of the rectangular base 15 so as to form a grid-like appearance. The plurality of cross channels have width and/or depth that progressively increases from the back wall 25 to the front edge 30 of the upper planar surface of the rectangular base 15. Additionally, the progressively increasing depth of the plurality of channels extending from the back wall 25 to the front edge 30 of the upper planar surface equals that of the plurality of cross channels at their points of intersection. The progressively increasing depth of the plurality of channels extending from the back wall 25 to the front edge 30 of the upper planar surface is thus characterized by a gradient that equals that of the progressively increasing depth of the plurality of cross channels.

Fluid running down the plurality of channels 35 and plurality of cross channels 110 gathers speed and creates a widening and deepening fluid flow. The grid-like design of the channels 35 and cross channels 110 provide adequate interconnected paths that keep fluid flowing toward the outdoors. Additionally, providing this interconnected grid accommodates any clogs that might otherwise trap fluid between the threshold 60 and the subfloor 55. The construction element 10 provides sufficient fluid paths and outlets to allow for diverting fluid around a clog.

In addition to the plurality of channels 35 and the plurality of cross channels 110, the vertically oriented ribs 45 protruding from the front flange 40 provide another mechanism by which fluid diverts away from a structure. Because a kickboard 95 attaches to the vertically oriented ribs 45, a gap, or drainage volume, exists between the front flange 40 the kickboard 95. Attaching the kickboard 95 to the vertically oriented ribs 45 enables fluid diverted by the plurality of channels 35 and cross channels 110 to flow out from the structure behind the kickboard 95 and to the ground, away from the structure.

The vertically oriented ribs 45, plurality of channels 35 and plurality of cross channels 100 are design elements formed in a preferably lightweight, durable material. The construction element 10 may be formed from any number of durable, lightweight materials such as but not limited to aluminum, steel or plastic. Such plastic material may be a plastic polymer material selected from group including, but not limited to, polypropylene, polyethylene, polystyrene, acrylic or any number of durable plastics typically used in construction materials. The construction element 10 may be formed through an injection molding process, such as one requiring a simple, two part mold, or the construction element 10 may be formed through other simple manufacturing techniques, such as a milling process or hot press process.

In conjunction with material selection, the construction element 10 provides a rectangular base 10 that is durable enough to fully support the threshold 60 and to carry the weight of the door 65 and any people or devices, such as occupied wheel chairs and load bearing dollies, entering and exiting the structure. The quantity and width of each of the plurality of channels 35 and the plurality of cross channels 110 are variable so as to provide adequate surface area of the upper planar surface of the rectangular base 15 for accommodating these downward forces from the threshold 60, the door 65 and any doorway traffic.

In addition to withstanding these forces following installation, the durable material forming the construction element 10 preferably is easily trimmed at a construction site using typical construction saws and other severing devices. Alternatively, the side flanges 50 and the front flange 40 may include one or more frangible lines along which those elements may be shortened by severing the frangible line. For example, the front flange protects a structure from water redirected by plurality of channels 35 and vertically oriented ribs 45. The front flange 40 thus necessarily extends downward far enough to accommodate a standard doorway step. Providing a means for shortening this length of the front flange 40 enables accommodation of any rise shorter than a standard rise.

It is noted that the foregoing examples have been provided merely for the purpose of explanation and are in no way to be construed as limiting of the present invention. While the present invention has been described with reference to an exemplary embodiment, it is understood that the words, which have been used herein, are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

I claim:

1) A formed construction element for providing drainage from beneath an entry door threshold, the formed construction element comprising:
a) a rectangular base having left and right sidewalls and a back wall that are interconnected projecting vertically upward from an upper planar surface, the upper planar surface having a front edge, the rectangular base being adaptable for:
i) attachment to a subfloor; and
ii) receiving a threshold;
the upper planar surface comprising a plurality of channels extending from the back wall to the front edge of the upper planar surface, the channels being pitched to carry fluid by gravity flow from the back wall to the front edge of the rectangular base; and
b) a front flange attached to the front edge of a bottom planar surface of the rectangular base and the left and right sidewalls of the rectangular base, the front flange further comprising a plurality of vertically oriented ribs which provide an attachment surface for an entry kickboard which creates drainage volume between the front flange and the entry kickboard.

2) The formed construction element of claim 1 wherein the upper planar surface further comprises a plurality of cross channels extending from the left side wall to the right sidewall and intersecting the plurality of channels extending from the back wall to the front edge of the rectangular base, thereby providing for enhanced drainage of the upper planar surface.

3) The formed construction element of claim 2 wherein the plurality of cross channels extending from the left side wall to the right sidewall are further characterized as having a width and/or depth that progressively increases from the back wall to the front edge of the upper planar surface.

4) The formed construction element of claim 1 wherein the plurality of channels extending from the back wall to the front edge of the upper planar surface are further characterized as having a width and/or a depth that progressively increases from the back wall to the front edge of the upper planar surface.

5) The formed construction element of claim 4, wherein the progressively increasing depth of the plurality of channels extending from the back wall to the front edge of the upper planar surface equals that of the plurality of cross channels at their points of intersection.

6) The formed construction element of claim 1 wherein the front flange further comprises a plurality of channels arranged vertically between the vertically oriented ribs.

7) The formed construction element of claim 1 wherein the element is formed from a strong, lightweight, durable material.

8) The formed construction element of claim 8 wherein the material is a plastic polymer material selected from a group consisting of polypropylene, polyethylene, polystyrene, and acrylic.

9) The formed construction element of claim 8 wherein the element is formed through an injection molding manufacturing process.

10) The formed construction element of claim 9 wherein the injection molding manufacturing process comprises a two part mold.

11) The formed construction element of claim 8 wherein the element is formed through a milling manufacturing process.

12) The formed construction element of claim 1 wherein the element is formed through a hot press manufacturing process.

13) The formed construction element of claim 1 wherein the back wall rises from the upper planar surface to a distance that is no higher than any adjacent material so that the back wall is hidden from view.

14) The formed construction element of claim 1, wherein the depth dimension of the rectangular base as measured from the front edge to the back wall is great enough to accommodate construction materials therebeneath including any of a water barrier material, a house wrap material, framing material, exterior sheathing and interior sheathing behind the front flange.

15) The formed construction element of claim 1, wherein the front flange further comprises side extensions for accommodating a variety of widths of door trim.

16) The formed construction element of claim 1, wherein the front flange extends downward from the lower planar surface at a vertical drop large enough to accommodate a standard rise.

17) The formed construction element of claim 16, further providing one or more frangible lines for removing one or more portions of the front flange to accommodate any rise shorter than a standard rise.

18) The formed construction element of claim 1, wherein the threshold abuts the upper planar surface with no sealant therebetween.

19) A method of using a construction device for providing drainage from beneath an entry door threshold, the method comprising:
a) providing a construction device comprising:
i) a rectangular base having left and right sidewalls and a back wall that are interconnected projecting vertically upward from an upper planar surface, the upper planar surface having a front edge, the rectangular base being adaptable for:
(1) engaging with a subfloor; and
(2) receiving a threshold;
the upper planar surface comprising a plurality of channels extending from the back wall to the front edge of the upper planar surface, the channels being pitched to carry fluid by gravity flow from the back wall to the front edge of the rectangular base; and
ii) a front flange attached to the front edge of a bottom planar surface of the rectangular base and the left and right sidewalls of the rectangular base, the front flange further comprising a plurality of vertically oriented ribs which provide an attachment surface for an entry kickboard and which direct fluid drainage volume between the front flange and the entry kickboard;
b) positioning the construction device on the subfloor positioned beneath an entry door; and
c) positioning a threshold on the construction device.

20) The method of claim 19 wherein the upper surface further comprises a plurality of cross channels that extend from the left side wall to the right sidewall and that intersect the plurality of channels extending from the back wall to the front edge of the rectangular base, thereby providing for enhanced drainage of the upper planar surface.

21) The method of claim 20 wherein the plurality of cross channels extending from the left side wall to the right sidewall are further characterized as having a width and/or depth that progressively increases from the back wall to the front edge of the upper planar surface.

22) The method of claim 19 wherein the plurality of channels extending from the back wall to the front edge of the upper planar surface are further characterized as having a width and/or a depth that progressively increases from the back wall to the front edge of the upper planar surface.

23) The method claim 22, wherein the progressively increasing depth of the plurality of channels extending from the back wall to the front edge of the upper planar surface is characterized by a gradient that equals that of the progressively increasing depth of the plurality of cross channels such that the plurality of channels and the plurality of cross channels have matching depths at their points of intersection.

24) The method of claim 19 further comprising installing one or more layers of a water barrier material between the device and the subfloor.

25) The method of claim 18 further comprising applying an adhesive layer between the device and the subfloor.

26) The method of claim 19 wherein the front flange further comprises a plurality of channels disposed vertically between the vertically oriented ribs.

27) The method of claim 19 wherein the back wall rises from the upper planar surface to a distance no higher than any adjacent material so that the back wall is unseen.

28) The method of claim 19 wherein the depth dimension of the rectangular base as measured from the front edge to the back wall is great enough to accommodate typical construction materials including any of a water barrier material, a house wrap material, framing material, exterior sheathing and interior sheathing behind the front flange.

29) The method of claim 19 wherein the device further comprises forming front flange side extensions that accommodate a variety of widths of door trim.

30) The method of claim 18 wherein the front flange extends downward from the lower planar surface at a vertical drop large enough to accommodate a standard doorway step.

31) The method of claim 30 further comprising cutting the front flange to accommodate any rise shorter than a standard rise.

32) The method of claim 31 wherein the front flange further provides one or more frangible lines for removing one or more portions of the front flange to accommodate any rise shorter than a standard rise.
